(19) United States
(12) Patent Application Publication
(10) Pub. No.: US 2009/0139495 A1
(43) Pub. Date: Jun. 4, 2009

(54) CARBON CANISTER WITH PURGE BUFFER SYSTEM

(75) Inventor: Jason M. Crawford, Connersville, IN (US)

Correspondence Address: BARNES & THORNBURG LLP, 11 SOUTH MERIDIAN, INDIANAPOLIS, IN, 46204, US

(73) Assignee: STANT MANUFACTURING INC., Connersville, IN (US)

(21) Appl. No.: 12/254,117

(22) Filed: Oct. 20, 2008

Related U.S. Application Data
(60) Provisional application No. 60/991,128, filed on Nov. 29, 2007.

(51) Int. Cl. F02M 33/02

(52) U.S. Cl. 123/519

(57) ABSTRACT

A carbon canister includes a housing and a carbon bed located in the housing. A discharge tube is coupled to the housing and arranged to conduct fuel vapor from the canister to a vapor-delivery system coupled to an engine to clean the carbon bed in the housing.

This application claims priority under 35 U.S.C. §119(e) to U.S. Provisional Application Ser. No. 60/991,128, filed Nov. 29, 2007, which is expressly incorporated by reference herein.

### BACKGROUND

The present disclosure relates to a vehicle fuel system, and particularly to a fuel vapor venting system associated with a vehicle fuel tank. More particularly, the present disclosure relates to a fuel vapor recovery canister included in the fuel vapor venting system.

Engine fuel systems include valves associated with a fuel tank and configured to vent pressurized or displaced fuel vapor from the vapor space in the fuel tank to a separate charcoal canister. The canister is designed to capture and store hydrocarbons entrained in fuel vapors that are displaced and generated in the fuel tank.

When an engine is running, a purge vacuum is applied to the charcoal canister via the engine intake manifold. Hydrocarbons stored (e.g., adsorbed) on charcoal held in the canister is entrained into a stream of atmospheric air drawn into the canister by the purge vacuum. This produces a stream of fuel vapor laden with reclaimed hydrocarbon material that is discharged from the canister through a purge hose into the intake manifold for combustion in the engine.

### SUMMARY

A fuel vapor recovery apparatus in accordance with the present disclosure includes a carbon canister comprising a housing and a carbon bed in the housing. The carbon bed is coupled in fluid communication to a tank vent control system associated with a fuel tank and an engine.

In illustrative embodiments, the fuel vapor recovery apparatus further includes a transfer conduit having a bed siphon that extends into the carbon bed provided in the housing to communicate with fuel vapor present in the carbon bed. A vacuum generated by the engine draws fuel vapor extant in the carbon bed into the bed siphon during regeneration of the carbon bed and then the fuel vapor exiting the bed siphon is conducted through a vapor-delivery system into the engine and burned.

In illustrative embodiments, the transfer conduit also includes a siphon portal configured to communicate fuel vapor from the bed siphon to a vapor-delivery system coupled to the engine. An illustrative siphon portal includes a discharge tube coupled to the vapor-delivery system and a filter unit arranged to interconnect the bed siphon and the discharge tube. Fuel vapor exiting the bed siphon in response to a suction force generated in the engine passes in series through the filter unit and the discharge tube before it is discharged from the transfer conduit into the vapor-delivery system and communicated to the engine.

Additional features of the disclosure will become apparent to those skilled in the art upon consideration of the following detailed description of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a diagrammatic view of an engine fuel system including a carbon canister in accordance with the present disclosure and showing a transfer conduit for conducting air laden with hydrocarbon material removed from the surface of carbon granules packed together to form upper and lower carbon beds contained in a canister housing and showing that the transfer conduit includes a bed siphon comprising a primary air inlet extending through a vapor chamber and the upper carbon bed to reach the lower carbon bed and an auxiliary air inlet extending through the vapor chamber to reach the upper carbon bed;

FIG. 2 is a diagrammatic view of an illustrative embodiment of an engine fuel system in accordance with the present disclosure showing export of fuel vapor generated by liquid fuel sloshing about in a fuel tank to an illustrative carbon canister including a transfer conduit configured to discharge hydrocarbons collected in the carbon bed to the engine to be burned in the engine;

FIG. 3 is a perspective view of an illustrative embodiment of a carbon canister in accordance with the present disclosure showing a vertical discharge tube included in the transfer conduit and arranged to extend upwardly through an aperture formed in a top end cap included in the carbon canister;

FIG. 4 is an exploded assembly view of some of the components included in the carbon canister of FIG. 5 showing (from top to bottom) the top end cap including the vertical discharge tube and an upper filter-chamber shell, a foam conduit filter included in the transfer conduit and sized to extend into a filter-receiving space formed in the upper filter-chamber shell, a filter mount including an oblong grid panel, a lower filter-chamber shell sized to mate with the upper filter-chamber shell and to receive a portion of the conduit filter, and a vertical tubular bed siphon included in the transfer conduit, an oblong top end filter formed to include an aperture sized to receive the vertical tubular bed siphon therein when the components are assembled to produce the carbon canister (as suggested in FIG. 5), and an upper portion of a canister housing containing a carbon bed comprising carbon granules;

FIG. 5 is an enlarged sectional view of an upper portion of the carbon canister taken along line 5-5 of FIG. 3 and a diagrammatic representation of other components included in an illustrative engine fuel system in accordance with the present disclosure and showing migration of fuel vapor exhausted from a vehicle fuel tank through a vapor chamber provided in the carbon canister into a carbon bed included in the carbon canister while the vehicle engine is off;

FIG. 6 is a sectional and diagrammatic view similar to FIG. 5 showing purging of the carbon bed in the canister housing by means of a purge vacuum applied by an engine to the carbon bed via the transfer conduit and showing flow of hydrocarbon-laden air (represented by dotted lines) from a lower carbon bed via a primary air inlet provided at the bottom of a bed-siphon tube included in the transfer conduit and arranged to extend into the carbon bed to reach the lower carbon bed and flow of hydrocarbon-laden air (represented by solid lines) from an upper carbon bed via an auxiliary air inlet provided in a mid-section of the bed-siphon tube during vacuum-induced regeneration of the carbon bed;

FIGS. 7 and 8 show another embodiment of a carbon canister in accordance with the present disclosure in which the auxiliary air inlet of the bed siphon of the transfer conduit is located in a different location in the canister housing to communicate with the vapor chamber in the canister housing;

FIG. 7 is an exploded perspective assembly view of components included in another illustrative carbon canister wherein the auxiliary air inlet of the bed siphon is formed in a wall of a filter-chamber shell included in the top end cap and, in an alternative embodiment (shown in phantom) the auxiliary air inlet of the bed siphon is formed in a wall of a filter-chamber shell included in the oblong grid;

FIG. 8 is a sectional view taken along line 8-8 of FIG. 7 (after assembly of components shown in FIG. 7), with portions broken away, showing the location of the alternative auxiliary air inlet of the bed siphon shown (in solid) in FIG. 7; and

FIG. 9 is a diagrammatic view of an engine fuel system including a U-flow carbon canister in accordance with another embodiment of the present disclosure showing a transfer conduit having a bed siphon arranged to communicate with upper and lower carbon beds included in a first filter provided in the U-flow carbon canister.

### DETAILED DESCRIPTION

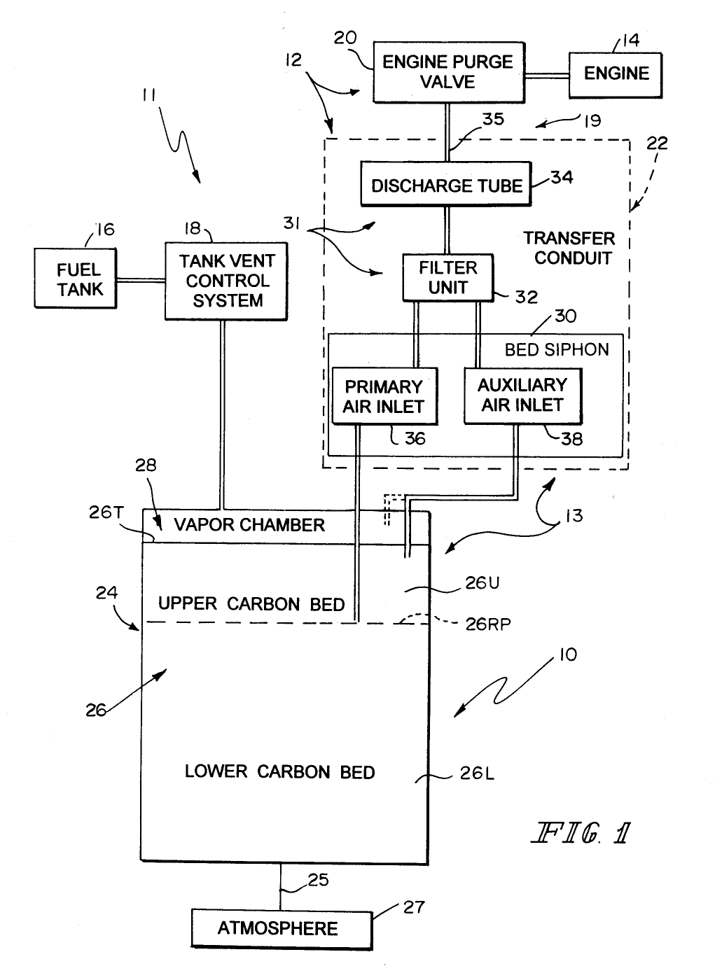

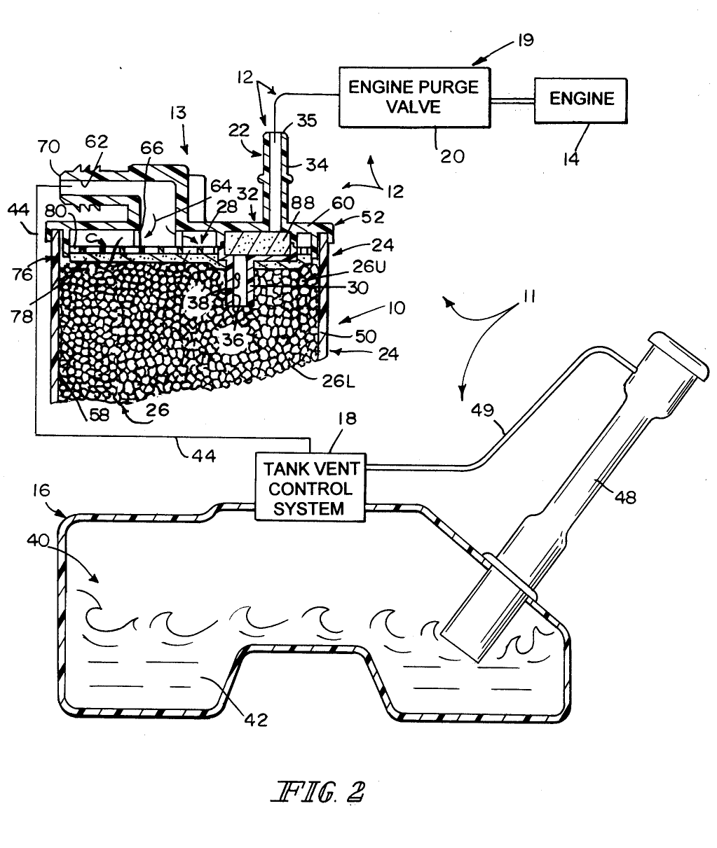

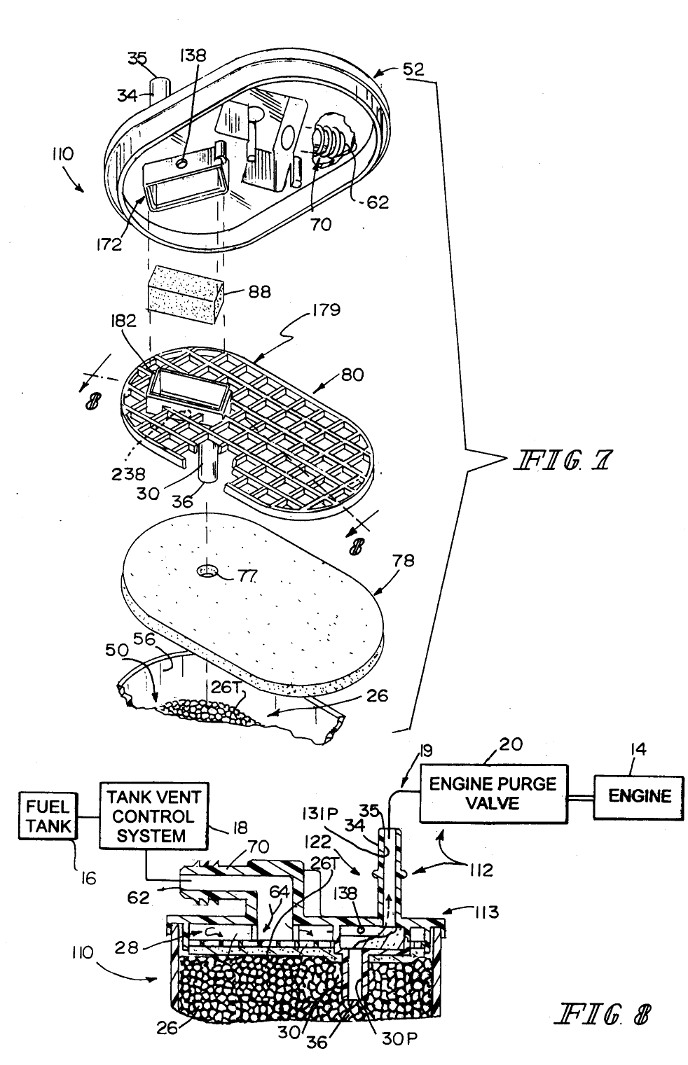

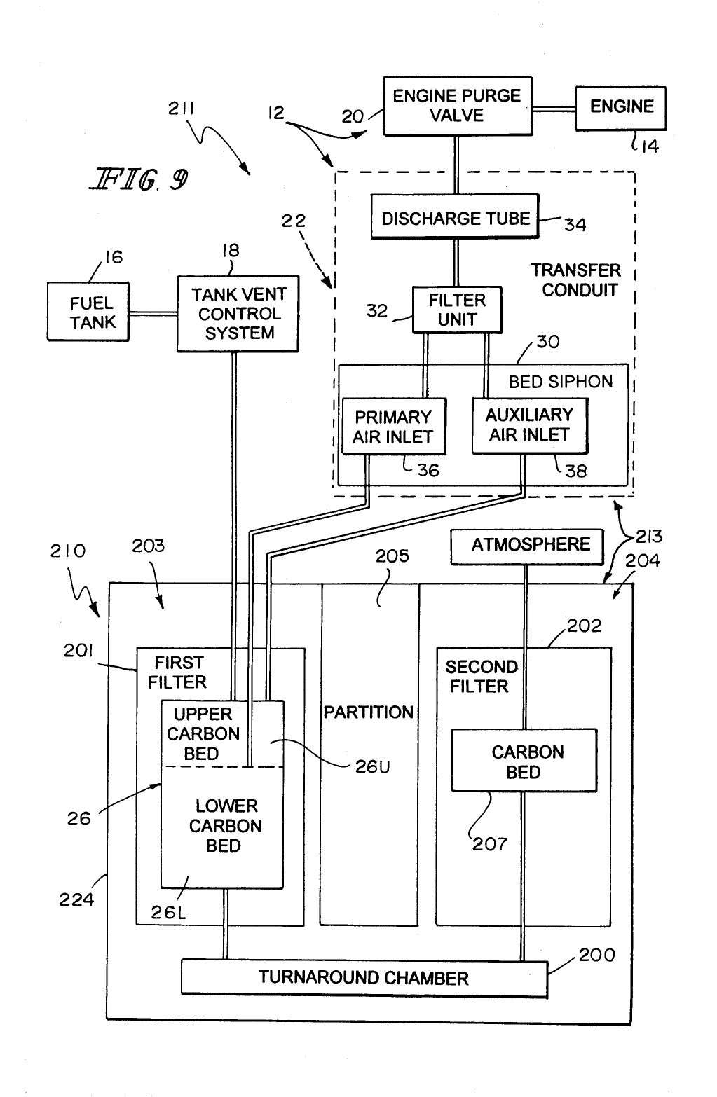

A carbon canister 10 in accordance with the present disclosure is coupled to a canister-purge system 12 associated with an engine 14 and is shown diagrammatically in FIG. 1 and illustratively in FIGS. 2-6. A carbon canister 110 in accordance with another illustrative embodiment of the present disclosure is coupled to a canister-purge system 112 and is shown in FIGS. 7 and 8. A carbon canister 210 in accordance with yet another embodiment of the present disclosure is shown diagrammatically in FIG. 9. In the embodiments shown in FIGS. 1-9, a carbon canister includes a carbon bed and a portion of a transfer conduit included in a canister-purge system is arranged to extend into the carbon bed so that at least some of the vapor purged from the canister must pass through the carbon bed before it reaches the engine.

As suggested diagrammatically in FIG. 1, canister 10 is included in an engine fuel system 11 comprising canister-purge system 12, engine 14, fuel tank 16, and tank vent control system 18. Canister-purge system 12 includes a vapor-delivery system 19 coupled to engine 14 and a transfer conduit 22 coupled to canister 10 and to vapor-delivery system 19. In illustrative embodiments, vapor-delivery system 19 includes an engine purge valve 20.

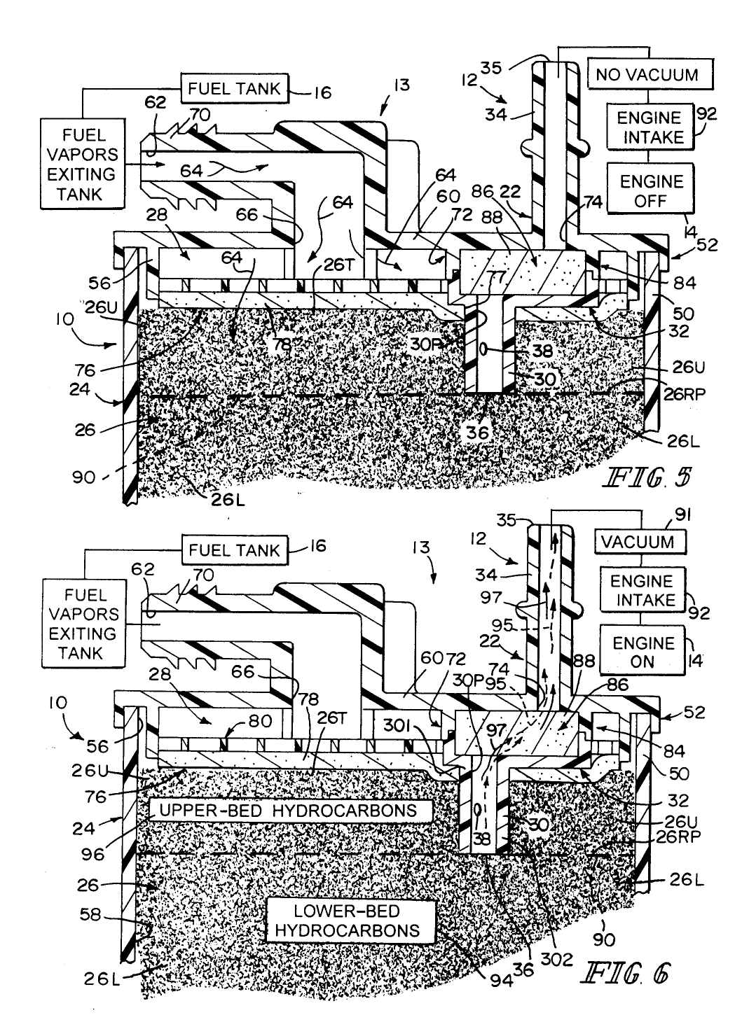

A fuel vapor recovery apparatus 13 includes canister 10 and transfer conduit 22. Canister 10 includes a housing 24 containing a carbon bed 26 and a vapor chamber 28. Housing 24 is formed to include an outside-air port 25 open to atmosphere 27 as suggested in FIG. 1. As suggested in FIG. 1, carbon bed 26 comprises a lower carbon bed 26L and an upper carbon bed 26U interposed between lower carbon bed 26L and vapor chamber 28. Vapor chamber 28 is coupled to fuel tank 16 by tank vent control system 18 to cause fuel vapor 64 discharged from fuel tank 16 into tank vent control system 18 to flow into vapor chamber 28 and then into carbon bed 26 as suggested in FIGS. 2 and 6. Hydrocarbon material extant in such fuel vapor 64 is captured in carbon bed 26 and clean air separated from the hydrocarbon material is discharged from housing 10 through outside-air port 25 formed in housing 10.

Canister 10 is configured to clean fuel 64 vapor vented from fuel tank 16 through tank vent control system 18 during tank refueling. Canister 10 is cleaned or purged to remove hydrocarbon material adsorbed onto carbon granules comprising carbon bed 26 using a vacuum provided by engine 14 when engine 14 is running and communicated to canister 10 via vapor-delivery system 19 and transfer conduit 22. Air is drawn through outside-air port 25 into carbon bed 26 whenever a vacuum generated in engine 14 is applied to carbon bed 26 via vapor-delivery system 19 and transfer conduit 22.

As shown diagrammatically in FIG. 1, transfer conduit 22 includes a bed siphon 30 coupled to carbon bed 26 and a siphon portal 31 coupled to bed siphon 30. Bed siphon 30 is arranged to extend into canister housing 24 and into carbon bed 26. Siphon portal 31 is adapted to be coupled to vapor-delivery system 19. Bed siphon 30 and siphon portal 31 cooperate to provide means for transferring a vacuum generated by engine 14 from vapor-delivery system 19 to carbon bed 26 and for transferring fuel vapor from carbon bed 26 to vapor-delivery system 19 so that such fuel vapor can be burned in engine 14.

Siphon portal 31 comprises, in an illustrative embodiment, a discharge tube 34 coupled to vapor-delivery system 19 and a filter unit 32 arranged to interconnect bed siphon 30 and discharge tube 34 in fluid communication with one another as suggested diagrammatically in FIG. 1 and illustratively in FIGS. 2 and 5. A first portion of siphon portal 31 (e.g., filter unit 32) lies partly inside canister housing 24 and a second portion of siphon portal 31 (e.g., discharge tube 34) lies partly outside canister housing 24. Siphon portal 31 is formed to include a fuel-vapor outlet 33 adapted to be coupled to the vapor-delivery system 19 that is coupled to engine 14 as suggested in FIG. 1.

Bed siphon 30 provides means for communicating a vacuum (i.e., negative pressure) produced in engine 14 to carbon bed 26 and for conducting vapor extant in an interior region 26, 28 of canister housing 24 to filter unit 32 in siphon portal 31 en route to vapor-delivery system 19 and engine 14. As suggested diagrammatically in FIG. 1, bed siphon 30 extends through vapor chamber 28 and upper carbon bed 26U.

Bed siphon 30 comprises a primary air inlet 36 exposed to fuel vapor extant in lower carbon bed 26L. Bed siphon 30 also comprises an auxiliary air inlet 38 that, in one embodiment (shown in solid) is exposed to fuel vapor extant in upper carbon bed 26U, and, in another embodiment (shown in phantom), is exposed to fuel vapor extant in vapor chamber 28. Bed siphon 30 is arranged to lie in fluid communication with each of carbon bed 26 inside canister housing 24 and filter unit 32 of siphon portal 31 as suggested diagrammatically in FIG. 1 and illustratively in FIGS. 2 and 5.

In each embodiment shown in FIG. 1, most of the fuel vapor 64 that is discharged into vapor chamber 28 from fuel tank 16 (e.g., during tank refueling or during times when liquid fuel 42 sloshes about inside fuel tank 16) is constrained to pass into and through carbon bed 26 before such fuel vapor 64 can flow into bed siphon 30 in transfer conduit 22 through primary air inlet 36. In one embodiment (shown in solid in FIG. 1), all remaining fuel vapor 64 extant in canister housing 24 must pass at least through upper carbon bed 26U before it can flow into bed siphon 30 through auxiliary air inlet 38. In another embodiment (shown in phantom in FIG. 1), some remaining fuel vapor 64 extant in canister housing 24 may pass from vapor chamber 28 into bed siphon 30 through auxiliary air inlet 38.

An illustrative embodiment of fuel system 11 is shown in FIG. 2 and an illustrative embodiment of a fuel vapor recovery apparatus 13 comprising carbon canister 10 and transfer conduit 22 is shown in FIGS. 2-6. As suggested in FIG. 2, fuel tank 16 has a saddle-bag shape and is formed to include an interior region 40 containing liquid fuel 42. On some occasions, liquid fuel 42 will slosh about in interior region 40 to generate fuel vapor that exits fuel tank 16 and is discharged by tank vent control system 18 into vapor space 28 in carbon canister 10 via conduit 44. Fuel system 11 also includes a fuel tank filler neck 48 coupled to fuel tank 16 and a fuel vapor recirculation conduit 49 coupled to tank vent control system 18 and filler neck 48.

An illustrative canister housing 24 is illustrated in FIGS. 2-6. In this embodiment, canister housing 24 includes a side wall 50, a top end cap 52, and a bottom end cap 54. Top end cap 52 is mounted on side wall 50 to close a top opening 56 into an interior region 58 bounded by side wall 50 and top and bottom end caps 52, 54 as suggested in FIGS. 2 and 4-6. Carbon bed 26 is disposed in interior region 58 as suggested in FIGS. 2 and 4-6 and vapor chamber 28 is formed above carbon bed 26 and below an end plate 60 included in top end cap 52 as suggested in FIGS. 2, 5, and 6. Carbon bed 26 comprises lots of small carbon granules as shown and these granules are compressed using any suitable means to establish the density of carbon bed 26. Some of the carbon granules contact an interior surface of side wall 50 of canister housing 24.

Fuel vapor 64 that is discharged from fuel tank 16 and admitted into interior region 58 of carbon canister 10 passes through carbon bed 26 as it flows toward bottom end cap 54. Such fuel vapor 64 is cleaned as it passes through carbon bed 26 to remove hydrocarbon material extant in fuel vapor 64. Hydrocarbon material entrained in fuel vapor 64 is adsorbed on the carbon granules included in carbon bed 26 and clean air is discharged from canister housing 24 through outside-air port 25 associated with bottom end cap 54 and the cleaned air is discharged to atmosphere 27 outside canister 10 or some other suitable destination.

Carbon bed 26 must be cleaned periodically to remove hydrocarbon material adsorbed on the carbon granules. Canister-purge system 12 is used to remove hydrocarbon materials from carbon bed 26 and conduct that hydrocarbon material through transfer conduit 22 so that it can be burned in engine 14.

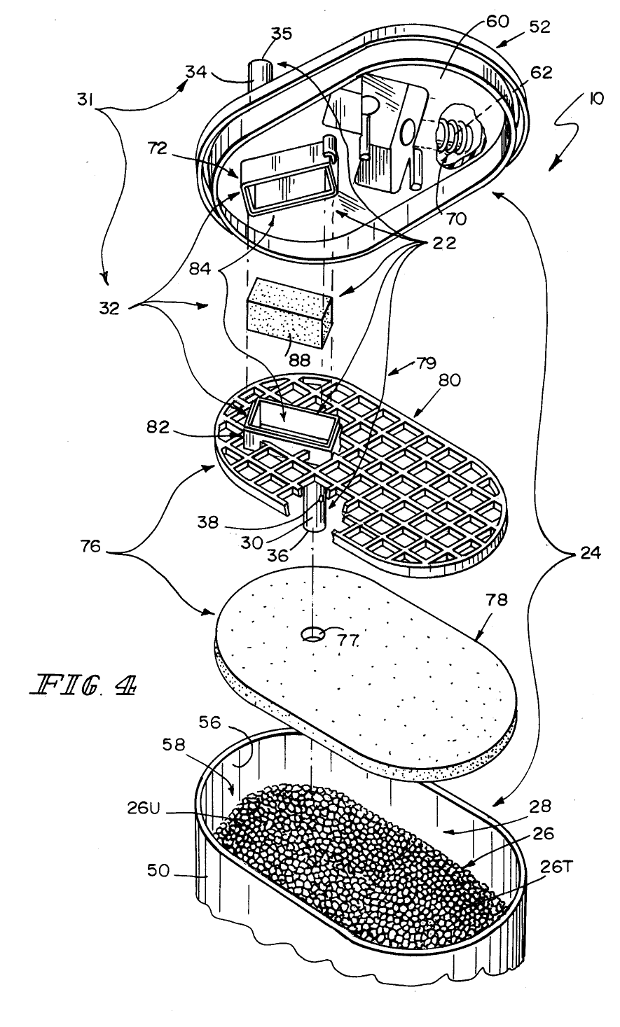

Top end cap 52 of canister 10 includes a vapor intake tube 70 configured to admit fuel tank fuel vapor 64 into vapor space 28 through tank-vapor port 66 formed in end plate 60 of top end cap as suggested, for example, in FIGS. 2 and 5. In an illustrative embodiment shown, for example, in FIG. 4, top end cap 52 is formed to include end plate 60 and a vapor-intake tube 70 is configured to define a vapor-conducting passageway 62 and coupled to an exterior portion of end plate 60. Discharge tube 34 is coupled to an exterior portion of end plate 60. A rectangular upper filter-chamber shell 72 is coupled to an interior portion of end plate 60 and arranged to communicate with discharge tube 34 via an aperture 74 formed in end plate 60 as shown, for example, in FIG. 5. Discharge tube 34 and upper filter-chamber shell 72 cooperate to form an upper portion of transfer conduit 22. In an illustrative embodiment, end plate 60, vapor-intake tube 70, and discharge tube 34 of transfer conduit 22 cooperate to form a monolithic component coupled to side wall 50 as shown in FIG. 5.

As suggested in FIG. 4, canister 10 also includes a bed retainer 76 comprising a top end filter 78 adjacent to carbon bed 26 and a filter mount 79 interposed between top end filter 78 and top end cap 52. Filter mount 79 includes a grid panel 80, a bed siphon 30 coupled to a downwardly facing portion of grid panel 80, and a rectangular lower filter-chamber shell 82 coupled to an upwardly facing portion of grid panel 80 as suggested in FIGS. 4 and 5. Bed siphon 30 is arranged to extend through an aperture 77 formed in top end filter 78 and into carbon bed 26 as suggested in FIGS. 4-6. Therefore, any fuel vapor that flows from interior region 58 of canister housing 24 to engine 14 via transfer conduit 22 must flow first through carbon bed 26 and then into bed siphon 30 of transfer conduit 22. Bed siphon 30 and lower filter-shell 82 cooperate to form a lower portion of transfer conduit 22. Filter mount 79 is a monolithic element in the embodiments illustrated in FIGS. 4-6 and in FIGS. 7 and 8.

Upper and lower filter-chamber shells 72, 82 mate to form a filter housing 84 having an interior region 86 sized to receive a conduit filter 88 therein as suggested in FIGS. 5 and 6 when the components comprising canister 10 are assembled. Conduit filter 88 is included in transfer conduit 22 and is configured to provide means for filtering fuel vapor flowing through transfer conduit 22 between canister 10 and engine 14.

Operation of carbon canister 10 is shown, for example, in FIGS. 5 and 6. Bed siphon 30 of transfer conduit 22 extends downwardly into carbon bed 26 to locate primary air inlet 36 in carbon bed 26 along an imaginary partition line 90 separating upper carbon bed 26U from lower carbon bed 26L. Bed siphon 30 is arranged to locate auxiliary air inlet 38 formed in bed siphon 30 in upper carbon bed 26U. Any fuel vapor that is extant in interior region 58 of canister housing 24 and is caused to flow into bed siphon 30 through either primary air inlet 36 or auxiliary air inlet 38 must first flow through a portion of carbon bed 26 (e.g., one or both of lower carbon bed 26L and upper carbon bed 26U). In this way, such fuel vapor is always exposed to carbon granules and hydrocarbon material extant in the fuel vapor will be adsorbed onto the carbon granules as the fuel vapor passes through carbon bed 26 and into transfer conduit 22 through inlets 36, 38 in bed siphon 30.

During operation of canister-purge system 12, a vacuum 91 generated by engine intake 92 when engine 14 is on is applied to carbon bed 26 via transfer conduit 22 as suggested in FIG. 6. This vacuum draws air from atmosphere 27 into canister housing 10 through outside-air port 25 and fuel vapor from carbon bed 26 into transfer conduit 22 so that it can flow through vapor-delivery system 19 to engine 14. Lower-bed hydrocarbons 94 adsorbed on carbon granules in lower carbon bed 26L are re-entrained into fuel vapor 95 drawn into bed siphon 30 of transfer conduit 22 through primary air inlet 36 during vacuum-induced regeneration of carbon bed 26 and those lower-bed hydrocarbons 94 are later burned in engine 14. A relatively small orifice is provided by auxiliary air inlet 38 to ensure that upper carbon bed 26U is cleaned during carbon-bed regeneration. When engine 14 pulls a vacuum on bed siphon 30, auxiliary air inlet 38 functions to draw some amount of vacuum in upper carbon bed 26U so as to clean the carbon granules in upper carbon bed 26U. Upper-bed hydrocarbons 96 adsorbed on carbon granules in upper carbon bed 26U are re-entrained into fuel vapor 97 drawn into bed siphon 30 through auxiliary air inlet 38 during regeneration of carbon bed 26 and those upper-bed hydrocarbons 96 are later burned in engine 14.

In the embodiments shown in FIGS. 7 and 8, the auxiliary air inlet is no longer formed in the tube providing bed siphon 30. Instead, auxiliary air inlet 138 is formed in upper filter-chamber shell 172 of filter mount 179 of transfer conduit 122 as shown in solid in FIGS. 7 and 8. Alternatively, auxiliary air inlet 238 could be formed in lower filter-chamber shell 182 as shown in phantom in FIG. 8. In such cases, some small amount of fuel vapor 64 extant in vapor chamber 28 is allowed to flow from vapor chamber 28 in canister housing 24 to engine 14.

During vehicle operation, engine 14 applies a vacuum 91 to canister 10 to draw out the stored hydrocarbon vapors from previous refueling events. Once canister 10 is cleaned, this purge air no longer will have hydrocarbon vapor in it. This causes the engine controller to adjust the air fuel ratio accordingly since there is no hydrocarbon present from the canister purge line. During a vehicle maneuver, fuel 42 will slosh in fuel tank 16. This slosh causes a sudden vapor generation, which engine 14 will see through the purging activity of canister 10. The controller is unable to adjust to this new vapor-rich signal in a time that is quick enough to keep engine 14 from stalling due to this slug of introduced vapor. Carbon canisters in accordance with the present disclosure minimize the engine stalling issue of the vehicle by slowing down this sudden vapor signal generation to a period of time that the engine controller can compensate for it.

Carbon canisters in accordance with the present disclosure use a communication tube such as bed siphon 30 that connects the purge inlet port of canister 10 to a point somewhere below the surface of carbon bed 26. This arrangement will force any hydrocarbon signal to be drawn through the cleaning activity of carbon bed 26 prior to the vapor exiting canister 10 and going to engine 14.

Purge tube 30 also includes an orifice 38. This orifice 38 allows the top of carbon bed 26 to be cleaned thoroughly without any loss of working capacity by having the tube 30 extended below the top of the carbon bed surface. Orifice 38 is used to meter the amount of signal to the engine controller unit and meter the amount of purging to the top of carbon bed 26.

Purge tube 30 is contained within the filtering structure (e.g., transfer conduit 22) of the canister inlet cover. This allows the tube 30 to bridge the filtering area and connect from the purge tube inlet to carbon bed 26. This purge tube 30 is also filtered by the filter media 88 contained in the inlet cover of canister 10.

Because this canister 10 buffers the purge signal (by use of the purge port) to engine 14, no working capacity is lost. The canister positive pressure drop is also reduced since the load side of canister 10 is not restricted by added tube length of filters. The ability of canister 10 to be purged clean of hydrocarbons is also not affected since the metered orifice 38 at the top of the tube 30 or in the plenum (i.e., vapor chamber 28 as shown in FIGS. 7 and 8) exposes the top surface of carbon bed 26 to purge air.

A carbon canister 210 in accordance with another embodiment of the present disclosure is shown diagrammatically in FIG. 9. Canister 210 is included in an engine fuel system 211 comprising canister-purge system 12, engine 14, fuel tank 16, and tank vent control system 18. Canister-purge system 12 includes a vapor-delivery system 219 (including an engine purge valve 20) coupled to engine 14 and a transfer conduit 22 coupled to canister 210 and vapor-delivery system 219. Fuel vapor recovery canister 213 includes canister 210 and transfer conduit 22.

As suggested in FIG. 9, canister 210 includes a housing 224 containing a first filter 201, a second filter 202, and a turnaround chamber 200. First filter 201 is located in a first chamber 203 and second filter 202 is located in a second chamber 204. A partition 205 is located in interior region 206 of canister housing 224 and arranged to separate first and second chambers 203, 204. Turnaround chamber 200 is arranged to interconnect first and second chambers 203, 204 in fluid communication to establish a U-shaped fuel vapor flow path through, in series, first chamber 203, turnaround chamber 200, and second chamber 204 as suggested in FIG. 9.

In an illustrative embodiment, first filter 201 comprises upper carbon bed 26U and lower carbon bed 26L as suggested in FIG. 9. Primary air inlet 36 of bed siphon 30 is exposed to vapor extant in lower carbon bed 26L in first filter 201. Auxiliary air inlet 38 of bed siphon 30 is exposed to vapor extant in upper carbon bed 26U in first filter 201. Second filter 202 comprises carbon bed 207 as suggested in FIG. 9.

In the embodiment of FIG. 9, the inlet port from fuel tank 16, purge port to engine 14, and exit port to the atmosphere are all formed on one end of canister housing 224. This establishes a U-shaped vapor flow path in canister housing 224. In contrast, the other embodiments disclosed herein are characterized by straight-through flow paths. In the embodiment shown diagrammatically in FIG. 9, bed siphon 30 extends into a carbon bed 26 included in a U-shaped canister 210 to provide a buffer for canister 210.

A fuel vapor recovery apparatus 13 includes a carbon canister 10 and a transfer conduit 22 as suggested in FIGS. 1-6. A similar transfer conduit 122 is coupled to carbon canister 110 to produce a fuel vapor recovery apparatus 113 as suggested in FIGS. 7 and 8. Conduit 22 is coupled to a carbon canister 210 as suggested in FIG. 9 to produce a fuel vapor recovery apparatus 213.

Carbon canister 10 includes a housing 24 and a carbon bed 26 as shown in FIGS. 1-6. Housing 24 is formed to include a tank-vapor port 66 adapted to receive fuel vapor 64 discharged from a fuel tank 16, and an outside-air port 25 open to the atmosphere 27. Carbon bed 26 is located in an interior region 58 formed in housing 24 and exposed to fuel vapor 64 generated in fuel tank 16 and admitted into housing 24 through tank-vapor port 66.

Transfer conduit 22 is configured as suggested in FIGS. 1-6 to provide means for communicating a vacuum produced in an engine 14 to carbon bed 26 in interior region 58 of housing 24 to cause a fuel vapor mixture laden with hydrocarbon material released from carbon bed 26 to be discharged from interior region 58 of housing 24 so that the fuel vapor mixture can be burned in engine 14. Transfer conduit 22 includes a siphon portal 31 formed to include a fuel-vapor outlet 35 adapted to be coupled in a vapor-delivery system 19 coupled to engine 14. Transfer conduit 22 further includes a bed siphon 30 arranged to extend into interior region 58 of housing 24 and into carbon bed 26 and formed to include a primary air inlet 36 located in carbon bed 26 to admit into the bed siphon 30 fuel vapor 64 extant in carbon bed 26 to ensure that some fuel vapor 64 admitted into interior region 58 of housing 24 through outside-air port 66 must pass through carbon bed 26 before entering bed siphon 30 through primary air inlet 36. Bed siphon 30 is arranged to interconnect carbon bed 26 and siphon portal 31 in fluid communication.

Carbon bed 26 comprises a lower carbon bed 26L and an upper carbon bed 26U interposed between tank-vapor port 66 and lower carbon bed 26L as suggested in FIGS. 1, 5, and 6. Bed siphon 30 includes a siphon tube 30 formed to include a vapor-conducting passageway 30P as suggested in FIGS. 5 and 6. Siphon tube 30 includes a first portion 301 coupled to siphon portal 31 and a second portion 302 located in carbon bed 26. Second portion 302 is formed to include primary air inlet 36 as suggested in FIGS. 5 and 6. Primary air inlet 36 is exposed to fuel vapor 64 extant in lower carbon bed 26L.

Upper carbon bed 26U includes a top surface 26T exposed to fuel vapor admitted into interior region 58 of housing 24 through tank-vapor port 66 as suggested in FIGS. 1, 5, and 6. Primary air inlet 36 is located in carbon bed 26 in spaced-apart relation to top surface 26T of upper carbon bed 26U and along a reference plane 26RP partitioning carbon bed 26 to establish upper and lower carbon beds 26U and 26L (as suggested in FIGS. 1, 5, and 6) to cause any fuel vapor 64 discharged into interior region 58 of housing 24 to pass at least through upper carbon bed 26U to reach lower carbon bed 26L before passing into vapor-conducting passageway 30P formed in bed siphon 30 through primary air inlet 36.

Housing 24 is formed to include a vapor chamber 28 located between tank-vapor port 66 and top surface 26T of carbon bed 26. Some of fuel vapor 64 discharged into vapor chamber 28 through tank-vapor port 66 is constrained to flow at least through upper carbon bed 26U and into lower carbon bed 26L to reach primary air inlet 36 of bed siphon 60 as shown in FIG. 6.

As suggested in FIGS. 1-6 and 9, siphon tube 30 is arranged to extend through upper carbon bed 26U and formed to include an auxiliary air inlet 38 exposed to fuel vapor 64 extant in upper carbon bed 26U and arranged to open into vapor-conducting passageway 26P and to lie in spaced-apart relation to and between tank-vapor port 66 and primary air inlet 36. Second portion 302 has a distal end that is formed to include primary air inlet 36 and a side wall that is formed to define a boundary of vapor-conducting passageway 30P and to include auxiliary air inlet 38 as suggested in FIGS. 5 and 6.

Siphon tube 30 is arranged to extend through upper carbon bed 26U and formed to include an auxiliary air inlet 38 located outside of carbon bed 26 and exposed to fuel vapor 64 extant in vapor chamber 28 as suggested in FIGS. 5 and 6. Auxiliary air inlet 38 is arranged to open into vapor-conducting passageway 26P and to lie in spaced-apart relation to primary air inlet 36. Auxiliary air inlet 38 has a size that is relatively smaller than a size of the primary air inlet.

As suggested in FIGS. 7 and 8, siphon portal 131 is formed to include a vapor-conducting passageway 131P coupled in fluid communication to vapor-conducting passageway 30P formed in bed siphon 30 and adapted to be coupled to a vapor-delivery system 19. Siphon portal 131 is also formed to include an auxiliary air inlet 36 exposed to fuel vapor 64 extant in vapor chamber 28 and arranged to open into vapor-conducting passageway 131P formed in siphon portal 131. Siphon portal 131 includes a discharge tube 34 adapted to be coupled to vapor-delivery system 19 and a filter unit 132 arranged to interconnect bed siphon 30 and discharge tube 34 in fluid communication with one another and formed to include auxiliary air inlet 138. Filter unit 132 includes a filter housing formed to include an interior region communicating with vapor-conducting passageway 30P formed in bed siphon 30 and vapor-conducting passageway 131P formed in siphon portal 131 and a conduit filter located in the interior region of the filter housing to filter fuel vapor 64 passing from vapor-conducting passageway 30P formed in bed siphon 30 into vapor-conducting passageway 131P formed in siphon portal 131 through interior region 58 of housing 24. The filter housing is formed to include auxiliary air inlet 138 to allow flow of fuel vapor 64 from vapor chamber 28 into the interior region of the filter housing.

Siphon portal 31 includes a discharge tube adapted to be coupled to vapor-delivery system 19 and a filter unit 32 arranged to interconnect bed siphon 30 and discharge tube 34 in fluid communication with one another to cause fuel vapor 64 exiting bed siphon 30 to pass through filter unit 32 before exiting siphon portal 31 and flowing into vapor-delivery system 19 as suggested in FIGS. 1, 5, and 6. Filter unit 32 includes a filter housing 84 formed to include an interior region communicating with vapor-conducting passageway 30P formed in bed siphon 30 and vapor-conducting passageway 31P formed in siphon portal 31 and a conduit filter 88 located in the interior region of filter housing 84 to filter fuel vapor 64 passing from vapor-conducting passageway 30P formed in bed siphon 30 into vapor-conducting passageway 31P formed in siphon portal 31 through interior region 58 of housing 24.

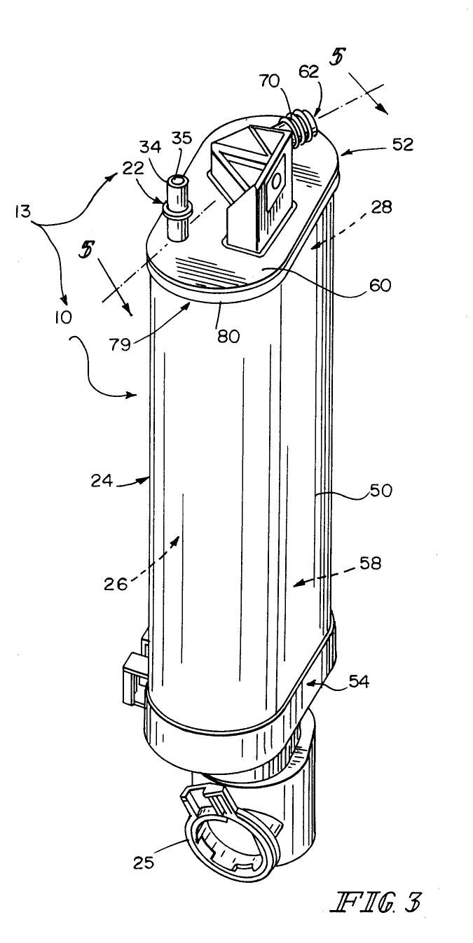

Housing 24 includes a top end cap 52, a bottom end cap 54 arranged to lie in spaced-apart relation to top end cap 52, and a side wall 50 arranged to interconnect and cooperate with top and bottom end caps 52, 54 to form interior region 58 therebetween as suggested in FIG. 3. Carbon bed 26 is located in interior region 58 formed in housing 24 and exposed to fuel vapor 64 generated in fuel tank 16 and admitted into interior region 58 of housing 24 through tank-vapor port 66.

Transfer conduit 22 is arranged to extend through top end cap 52 and into carbon bed 26 and configured to conduct fuel vapor 64 extant in carbon bed 26 out of interior region 52 of housing 24 and into vapor-delivery system 19. Transfer conduit 22 includes a discharge tube 34 located outside interior region 58 of housing 24 and adapted to be coupled to vapor-delivery system 19, a siphon tube 30 located inside interior region 58 of housing 24 and arranged to extend into carbon bed 26, and a filter unit 32 located inside interior region 58. Filter unit 32 is arranged to interconnect siphon tube 30 and discharge tube 34 in fluid communication with one another to allow fuel vapor 164 extant in carbon bed 26 to flow to vapor-delivery system 19, in series, through the siphon tube 30, filter unit 32, and discharge tube 34.

Canister 10 further includes a bed retainer 76 positioned to lie in interior region 58 of housing 24 in a location between top end cap 52 and carbon bed 26. Bed retainer 76 includes an inner surface arranged to face toward carbon bed 26 and coupled to siphon tube 30 and an outer surface arranged to face toward top end cap 52 and coupled to filter unit 32 as suggested in FIGS. 2-5. Bed retainer 76 includes a grid 80 providing the inner and outer surfaces and a top end filter 78 interposed between the grid 80 and carbon bed 26. Top end filter 52 is formed to include an aperture 77 as suggested in FIG. 4. Siphon tube 30 is arranged to extend through aperture 77 formed in top end filter 77 to reach carbon bed 26 as suggested in FIGS. 2, 5, and 6.

Filter unit 32 is also coupled to top end cap 52 and formed to include an interior region in communication with a vapor-conducting passageway formed in each of siphon tube 30 and discharge tube 34. Filter unit 32 also includes a conduit filter 88 located in the interior region of filter unit 32.

1. A fuel vapor recovery apparatus comprising
a carbon canister including a housing formed to include a tank-vapor port adapted to receive fuel vapor discharged from a fuel tank, an outside-air port open to the atmosphere, and a carbon bed located in an interior region formed in the housing and exposed to fuel vapor generated in a fuel tank and admitted into the housing through the tank-vapor port and
a transfer conduit configured to provide means for communicating a vacuum produced in an engine to the carbon bed in the interior region of the housing to cause a fuel vapor mixture laden with hydrocarbon material released from the carbon bed to be discharged from the interior region of the housing so that the fuel vapor mixture can be burned in the engine, wherein the transfer conduit includes a siphon portal formed to include a fuel-vapor outlet adapted to be coupled in a vapor-delivery system coupled to an engine, the transfer conduit further includes a bed siphon arranged to extend into the interior region of the housing and into the carbon bed and formed to include a primary air inlet located in the carbon bed to admit into the bed siphon fuel vapor extant in the carbon bed to ensure that some fuel vapor admitted into the interior region of the housing through the outside-air port must pass through the carbon bed before entering the bed siphon through the primary air inlet, and the bed siphon is arranged to interconnect the carbon bed and the siphon portal in fluid communication.

2. The apparatus of claim 1, wherein the carbon bed comprises a lower carbon bed and an upper carbon bed interposed between the tank-vapor port and the lower carbon bed, the bed siphon includes a siphon tube formed to include a vapor-conducting passageway, the siphon tube includes a first portion coupled to the siphon portal and a second portion located in the carbon bed, the second portion is formed to include the primary air inlet, and the primary air inlet is exposed to fuel vapor extant in the lower carbon bed.

3. The apparatus of claim 2, wherein the upper carbon bed includes a top surface exposed to fuel vapor admitted into the interior region of the housing through the tank-vapor port, the primary air inlet is located in the carbon bed in spaced-apart relation to the top surface of the upper carbon bed and along a reference plane partitioning the carbon bed to establish the upper and lower carbon beds to cause any fuel vapor discharged into the interior region of the housing to pass at least through the upper carbon bed to reach the lower carbon bed before passing into the vapor-conducting passageway formed in the bed siphon through the primary air inlet.

4. The apparatus of claim 3, wherein the housing is formed to include a vapor chamber located between the tank-vapor port and the top surface of the carbon bed and some of the fuel vapor discharged into the vapor chamber through the tank-vapor port is constrained to flow at least through the upper carbon bed and into the lower carbon bed to reach the primary air inlet of the bed siphon.

5. The apparatus of claim 2, wherein the siphon tube is arranged to extend through the upper carbon bed and formed to include an auxiliary air inlet exposed to fuel vapor extant in the upper carbon bed and arranged to open into the vapor-conducting passageway and to lie in spaced-apart relation to and between the tank-vapor port and the primary air inlet.

6. The apparatus of claim 5, wherein the second portion has a distal end that is formed to include the primary air inlet and a side wall that is formed to define a boundary of the vapor-conducting passageway and to include the auxiliary air inlet.

7. The apparatus of claim 2, wherein the housing is also formed to include a vapor chamber arranged to receive fuel vapor admitted into the interior region of the housing through the tank-vapor port, the upper carbon bed is located between the vapor chamber and the lower carbon bed, the siphon tube is arranged to extend through the upper carbon bed and formed to include an auxiliary air inlet located outside of the carbon bed and exposed to fuel vapor extant in the vapor chamber, and the auxiliary air inlet is arranged to open into the vapor-conducting passageway and to lie in spaced-apart relation to the primary air inlet.

8. The apparatus of claim 7, wherein the second portion has a distal end that is formed to include the primary air inlet and a side wall that is formed to define a boundary of the vapor-conducting passageway and to include the auxiliary air inlet.

9. The apparatus of claim 7, wherein the auxiliary air inlet has a size that is relatively smaller than a size of the primary air inlet.

10. The apparatus of claim 2, wherein the housing is also formed to include a vapor chamber arranged to receive fuel vapor admitted into the interior region of the housing through the tank-vapor port and to conduct fuel vapor from the tank-vapor port to the carbon bed for admission into the vapor-conducting passageway formed in the bed siphon through the primary air inlet, the siphon portal is formed to include a vapor-conducting passageway coupled in fluid communication to the vapor-conducting passageway formed in the bed siphon and adapted to be coupled to the vapor-delivery system, the siphon portal is also formed to include an auxiliary air inlet exposed to fuel vapor extant in the vapor chamber and arranged to open into the vapor-conducting passageway formed in the siphon portal.

11. The apparatus of claim 10, wherein the siphon portal includes a discharge tube adapted to be coupled to the vapor-delivery system and a filter unit arranged to interconnect the bed siphon and discharge tube in fluid communication with one another and formed to include the auxiliary air inlet.

12. The apparatus of claim 10, wherein the filter unit includes a filter housing formed to include an interior region communicating with the vapor-conducting passageway formed in the bed siphon and the vapor-conducting passageway formed in the siphon portal and a conduit filter located in the interior region of the filter housing to filter fuel vapor passing from the vapor-conducting passageway formed in the bed siphon into the vapor-conducting passageway formed in the siphon portal through the interior region of the housing, and wherein the filter housing is formed to include the auxiliary air inlet to allow flow of fuel vapor from the vapor chamber into the interior region of the filter housing.

13. The apparatus of claim 1, wherein the siphon portal includes a discharge tube adapted to be coupled to the vapor-delivery system and a filter unit arranged to interconnect the bed siphon and discharge tube in fluid communication with one another to cause fuel vapor exiting the bed siphon to pass through the filter unit before exiting the siphon portal and flowing into the vapor-delivery system.

14. The apparatus of claim 13, wherein the filter unit includes a filter housing formed to include an interior region communicating with the vapor-conducting passageway formed in the bed siphon and the vapor-conducting passageway formed in the siphon portal and a conduit filter located in the interior region of the filter housing to filter fuel vapor passing from the vapor-conducting passageway formed in the bed siphon into the vapor-conducting passageway formed in the siphon portal through the interior region of the housing.

15. The apparatus of claim 1, wherein the housing includes a side wall surrounding the carbon bed and a top end cap covering a top opening formed in the side wall and lying in spaced-apart relation to define a vapor chamber located therebetween to receive fuel vapor discharged into the interior region of the housing through the tank-vapor port, the transfer conduit is coupled to the top end cap and arranged to extend through an aperture formed in the transfer conduit, and the siphon portal includes a discharge tube located outside of the interior region of the housing and adapted to be coupled to the vapor-delivery system and a filter unit located in the interior region of the housing and arranged to interconnect the bed siphon and the discharge tube in fluid communication with one another to allow fuel vapor extant in the carbon bed to flow to the vapor-delivery system, in series, through the bed siphon, the filter unit, and the discharge tube.

16. A fuel vapor recovery apparatus comprising
a carbon canister including a housing formed to include a tank-vapor port adapted to receive fuel vapor discharged from a fuel tank and a carbon bed in the housing, the housing including a top end cap, a bottom end cap arranged to lie in spaced-apart relation to the top end cap, and a side wall arranged to interconnect and cooperate with the top and bottom end caps to form the interior region therebetween, the carbon bed being located in the interior region formed in the housing and exposed to fuel vapor generated in a fuel tank and admitted into the interior region of the housing through the tank-vapor port, and
a transfer conduit adapted to be coupled to a vapor-delivery system coupled to an engine and arranged to extend through the top end cap and into the carbon bed and configured to conduct fuel vapor extant in the carbon bed out of the interior region of the housing and into the vapor-delivery system, the transfer conduit including a discharge tube located outside the interior region of the housing and adapted to be coupled to the vapor-delivery system, a siphon tube located inside the interior region of the housing and arranged to extend into the carbon bed, and a filter unit located inside the interior region and arranged to interconnect the siphon tube and the discharge tube in fluid communication with one another to allow fuel vapor extant in the carbon bed to flow to the vapor-delivery system, in series, through the siphon tube, the filter unit, and the discharge tube.

17. The apparatus of claim 16, wherein the canister further includes a bed retainer positioned to lie in the interior region of the housing in a location between the top end cap and the carbon bed, the bed retainer includes an inner surface arranged to face toward the carbon bed and coupled to the siphon tube and an outer surface arranged to face toward the top end cap and coupled to the filter unit.

18. The apparatus of claim 17, wherein the bed retainer includes a grid providing the inner and outer surfaces and a top end filter interposed between the grid and the carbon bed, the top end filter is formed to include an aperture, and the siphon tube is arranged to extend through the aperture formed in the top end filter to reach the carbon bed.

19. The apparatus of claim 18, wherein the filter unit is also coupled to the top end cap and formed to include an interior region in communication with a vapor-conducting passageway formed in each of the siphon tube and the discharge tube and the filter unit also includes a conduit filter located in the interior region of the filter unit.

20. The apparatus of claim 16, wherein the top end cap includes an interior surface arranged to face toward the carbon bed and coupled to the filter unit and an exterior surface coupled to the discharge tube.

21. The apparatus of claim 20, wherein the canister further includes a bed retainer positioned to lie in the interior region of the housing in a location between the top end cap and the carbon bed, the bed retainer includes an inner surface arranged to face toward the carbon bed and coupled to the siphon tube and an outer surface arranged to face toward the top end cap and coupled to the filter unit.
